(19) United States
(12) Patent Application Publication
(10) Pub. No.: US 2021/0142238 A1
(43) Pub. Date: May 13, 2021

(54) SYSTEM FOR PRODUCING AND DELIVERING INFORMATION TECHNOLOGY PRODUCTS AND SERVICES

(71) Applicant: SNAPIT SOLUTIONS LLC, Overland Park, KS (US)

(72) Inventor: NEELIMA PARASKER, OVERLAND PARK, KS (US)

(21) Appl. No.: 17/094,729

(22) Filed: Nov. 10, 2020

Related U.S. Application Data
(60) Provisional application No. 62/933,857, filed on Nov. 11, 2019.

(51) Int. Cl. G06Q 10/06; G06Q 10/10; G06Q 30/02

(52) U.S. Cl. CPC G06Q 10/0633; G06Q 30/0206; G06Q 10/109; G06Q 10/0639

(57) ABSTRACT

Disclosed is a process and system for training information technology workers and providing information technology products. The process and system employ a regenerative cycle process that includes sensing, engaging, learning, and working functions for each information technology skill or function and for each stage of the cycle. The information technology products are of lower cost and higher quality to client businesses in need thereof.

### CROSS-REFERENCE TO RELATED APPLICATIONS

This application claims priority pursuant to 35 U.S.C. 119(e) to U.S. Provisional Patent Application No. 62/933,857, filed on Nov. 11, 2019, which is hereby incorporated by reference in its entirety.

### FIELD

The invention is generally in the field of information technology services. The invention specifically relates to providing improved customized and relevant information technology to end users. The invention is also generally in the field of training and producing qualified information technology providers.

### BACKGROUND

The information technology and computer industry is expected to outpace overall economic growth in the coming years. According to the Bureau of Labor Statistics Monthly Labor Review, technology job opportunities are predicted to grow at a rate that is faster than all other jobs in the professional sector, that is, up to 22% over the next decade. Demand for these workers stems from greater emphasis on cloud computing, the collection and storage of big data, and information security. Technology occupations are projected to add about 546,200 new jobs, thus, the current workforce will need significant upskilling and re-training to meet the ever changing technology innovations.

Despite the increasing number of computing jobs, interest in these majors and careers has steadily declined over the past decade. Fewer students are enrolling in computer science and graduating with computer science degrees. If current trends continue, the industry will only be able to fill half of its available jobs with candidates holding computer science bachelor's degrees from American universities. With the current four year degree requirement in computer science related jobs, it has been challenging to keep up the supply with the demand for talent, which has resulted in the shortage of tech workers.

Small companies with their innovative new technologies disrupt the industry but fail to sustain their growth due to the high-tech skills shortage. Larger organizations attract considerable interest in the technology job market but struggle to reskill their existing workforce in the fast-changing technology industry. According to Forbes, the state of IT Service Management in 2017, which included responses from 261 senior level executives globally, 50% of the respondents cited tech skills shortage and training requirements as the key challenge to IT transformation. The report found that while technology is disrupting the business landscape, the ability to effectively leverage the available solutions and deliver the necessary functions to end-users remained elusive due to the high-tech talent shortage. Thus, there is a significant unmet need for high-quality affordable information technology services, advice and products.

### SUMMARY

Disclosed are a dynamic and regenerative method and system for providing businesses and other organizations or individuals, which have limited resources and financial capabilities, value based information technology solution platforms that employ competent but underserved or underutilized job seeking individuals.

In one aspect, the invention provides an information technology training and delivery system. In one embodiment, the system includes a regenerative training cycle; a community; a plurality of students; an information technology training and service organization (ITTSO) that provides a trainer that trains one or more students; a training organization, such as a community college or workforce development center located within the community; a client that uses information technology services, advice, or products; and an information technology product.

In some embodiments, the geographic region is (i) part of one or more states, (ii) a combined statistical area, (iii) a metropolitan statistical area, (iv) a micropolitan statistical area, (v) a county, or (vi) a city or town with a population less than 500,000.

In one embodiment, the regenerative training cycle includes four stages including a probe stage, a trains stage, a solves stage, and a pods stage. In one embodiment, each of the four stages include four phases including a sense phase, an engage phase, a learn phase, and a work phase.

In one embodiment, the ITTSO is a for-profit company that provides information technology training and services.

In one embodiment, the information technology product is an information technology worker, a software product, software development services, or software advice.

In another aspect, the invention provides a method of training an information technology worker. In one embodiment, the method includes the steps of inducting a novice student into a training program, who is then a trainee student; delivering course material to the trainee; having the trainee work on a project and then present that project to one or more industry expert judges; inducting the trainee into an internship program at the ITTSO or a client company (who then becomes an inter) and training the intern in a real-world environment; inducting the intern into a paid position in an organization, preferably the ITTSO (the intern is now an apprentice); and mentoring the intern for several years. At the end of the process the, apprentice becomes a professional information technology worker.

In another aspect, the invention provides a method of providing an information technology product to a client business. In one embodiment, the method includes the steps of training an intern, apprentice, or worker in information technology skills according to the preceding aspect (supra); engaging a client business; interrogating the client business to understand in detail a workflow of the client business; and then providing an information technology product to the client business at below market cost for the level of quality of the information technology product.

In one embodiment, the provided information technology product is (i) an information technology worker, (ii) a software product, (iii) software development services, or (iv) software advice.

### DRAWINGS

FIG. 1 is a Venn diagram depicting a pedagogical and service providing system within a community.

FIG. 2 is a flow chart depicting the interaction among students, ITTSO and client business to provide economic benefits that include increased quality with decreased cost.

FIG. 3 is a flow chart depicting the progression of a novice individual through the system to become an information technology worker.

FIG. 4 is a flow chart depicting phase steps with a process and system.

FIG. 5 is a relational graphic depicting a stepwise process of learning to train an apprentice and deliver an IT work product.

FIG. 6 is a relational graphic depicting a stepwise process of engagement to train a trainee.

FIG. 7 is a flow chart depicting a system in which a student progresses along a sequence of stages from being a novice to a fully trained and effective information technology worker.

FIG. 8 is a flow chart depicting one full cycle of the regenerative system and method for training and providing information technology professionals. Each cycle contains fours stages of probes, trains, solves, and pods, and each stage contains four phases of sense, engage, learn, and work.

### DETAILED DESCRIPTION OF EMBODIMENTS

Before the present methods are described, it is to be understood that this invention is not limited to particular methods or systems described, as such methods or systems may vary. It is also to be understood that the terminology used herein is for the purpose of describing particular embodiments only, and is not intended to be limiting, since the scope of the present invention will be limited only by the appended claims.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth. Also, for example, a reference to “an intern” includes one or more interns.

Unless defined otherwise, all technical terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

The various embodiments of the system and method of the invention provide substantial advantages and improvements over current systems and methods for the training of unconventional students for information technology jobs and the provision of excellent and cost effective information technology services and advice.

A regenerative process or system, team or organization is one that connects every one of its people to its essential core—its unique foundation for innovation and market power. This provides the fulcrum for an organizational culture that embraces the internal destabilization and discomfort that comes with responding creatively to the unfamiliar.”

Disclosed are a system and method to develop information technology staff and provide efficient, effective, and low cost information technology services and solutions to small and medium size companies. In one aspect, the invention provides a system for providing information technology services. In another aspect, the invention provides a method for developing information technology workers. In another aspect, the invention provides a method for providing information technology services.

In one embodiment, the method includes an IT training and service organization (ITTSO) developing and providing custom designed courses (ITTSO stage one program) to expand opportunities in technology to a talent pool from a diverse, and under-resourced population of individuals. Here, graduates of the program can serve as interns and apprentices within the ITTSO or another organization requiring IT services. Every new hire (e.g., i.e., intern or apprentice) is paired with a senior technology expert in the particular area of information technology and mentored on the job for an expeditious and efficient learning curve. Each new hire is challenged to do the best they can to sharpen their skills and continue to be trained and develop additional skills while on the job.

In some embodiments, graduates of the ITTSO stage one program are trained to provide, and do provide, IT services such as e.g., software developer, coder, certified IT trainer, and the like. In some embodiments, graduates of the ITTSO stage one program are certified by a third party and granted the moniker of Junior Software Developers. In some embodiments, ≥50%, ≥55%, ≥60%, ≥65%, ≥70%, ≥75%, or ≥80% of Junior Software Developers are hired as interns or apprentices at ITTSO or another organization requiring IT services.

In some embodiments, the ITTSO employs apprentices that graduated from the ITTSO stage one program into an ITTSO stage two program. During the ITTSO stage two program, the ITTSO staff and employed apprentices engage with and assist small and medium businesses with custom-developed technology software products. Here, the apprentices work on real world projects with lesser demands in delivery timelines and complexity.

In some embodiments, the ITTSO stage two program apprentice is employed within a group or “pod” within the ITTSO. The pod further includes trained staff IT workers serving as mentors to the apprentice. Mentors are selected from a senior development team within the ITTSO. The apprentice in the pod provides software application development services to enhance a client business's existing system without requiring the client business to manage or direct the apprentice. The mentor(s) create scenarios and courses of action that help the intern and/or apprentice develop skills to become independent software developers, designers and testers within hi-tech industry.

For geographic areas that lack a significant technology industry or critical mass to create a “tech-hub,” in some embodiments, the ITTSO engages with and harnesses the vast reservoir of untapped potential and talent existing in those geographic areas, reducing or eliminating the need for ITTSO or other companies to import workforce from urban areas or other geographic areas. Here, local talent is developed.

Expediting experiential learning within the existing workforce and elevating the skills capability of employees presents lower risks and requires less cost and time investments than searching for and hiring individuals from outside the local area. Thus, in some embodiments, the ITTSO conducts intensive educational workshops ranging from design thinking and technical problem simulations to soft-skills and management training to train a local area workforce with the latest skills necessary to provide expert and cost-effective IT services, which allows organizations to scale the adoption and implementation of promising new digital technologies.

Other advantages conveyed by the disclosed training method and system include providing agility to traditional businesses, which otherwise would need to reorganize their organizational structure, and especially IT, to introduce such agility in the way the ITTSO pods, interns, and apprentices help to achieve business goals. Thus, in some embodiments, the ITTSO stage two program and resultant pod teams train interns, apprentices, and junior IT workers to self-manage and adopt standardized technologies designed to eliminate silos between disparate teams. Here, collaboration and coordination are streamlined among the diverse workforce teams or functions as the IT professionals, junior IT workers, apprentices, interns and their respective teams and pods apply the standardized processes and technologies as needed to promote integration of the diverse skills and workforce functions.

Oftentimes, IT services and functions are not very well embedded within the business or culture of a company even when technology functions at the core of the company. Thus, in some embodiments, the trainee, intern, apprentice, or junior IT worker is trained to develop a strong business sense. Especially when technology is at the core of the business offerings, these individuals are specifically trained to develop a strong understanding of how their roles and contributions impact the business and end-user experience of their business services. Thus, in some embodiments, the individuals are trained to deliver (and do deliver) improved support for larger number of users, improved capability to add new services, and increased support for a larger number of end-users. Here, the individuals are trained to go beyond the ability to solve technical challenges and to develop other necessary business skills, including understanding the ever-changing dynamics of the local and international business climate to apply IT to create solutions or business use cases that yield key competitive differentiation for the organization in the competitive market landscape.

With a strong business sense, the ITTSO trained individuals work together with executives to help the client company continuously adapt and redirect itself to better achieve organizational goals. While IT is primarily responsible to address the technical problems facing the business organization, IT can frequently contribute to identify profitable new pathways for the technology-enabled business service. These contributions can reduce the expense on external contractors that may not entirely understand the inner workings of the organization, its services, culture and the resulting impact on its business and end-users.

The IT talent gap is often not about the specific technology skills but the ability of the workforce to solve technical and business problems that require creativity and strong ideation beyond implementing previously known knowledge concepts or information. In some embodiments, individuals are trained to improve high-order cognitive capability, creativity, ideation, and problem-solving skills.

In some embodiments, the pre-trained and trained individuals are selected from individuals that are underrepresented in the information technology workforce. While it's well-known that women make key contributions to the economy, gender disparities remain, particularly in the tech industry. Being outnumbered, underpaid, and overlooked in comparison to their male counterparts, women have notoriously faced bigger challenges than men, forcing many women to ultimately leave their tech positions. More than half of women in tech leave the industry by the mid-point of their career, which is more than double the rate of men, according to 2019 Center for Work-Life Policy study. Thus, in some embodiments, the individuals selected for the ITTSO stage one program are selected from an underrepresented group, such as women.

Here, the ITTSO includes an infrastructure that includes an entrepreneurial ecosystem that ensures access to a vibrant ecosystem that includes all groups of individuals, including women and minorities. The entrepreneurial ecosystem includes intentional corporate investment in small businesses.

### Regenerative Learning System

Prior art systems for training IT workers and providing high quality IT business services prioritize knowing over doing and have the potential to severely compromise the development of design self-efficacy in students. At the same time, the world has witnessed a major shift in the dominant technology in society. Innovation has been disruptive to a lot of processes. In most cases there appears to be a phase after the introduction of an innovation in which process ceases to exist.

Disclosed is a regenerative learning and IT services delivery process and system that operate to continue the innovative process during the prior art waning phase of innovation. The subject regenerative process and system employ an operating system with nested functional units, such as individuals (e.g., pre-trainees, trainees, interns, apprentices, junior IT workers, mentors, and senior IT workers), as teams (e.g., the ITTSO, pods, and teams), as communities (e.g., interinstitutional cooperatives, such as ITTSO-client company community, and local regions of interrelated industries and markets), as regions (e.g., mufti-state and economically joined regions), and as a planet.

In some embodiments, individuals selected as pre-trainees (referred herein also as naïve individuals) are selected from segments of the population that are marginalized and are without access to new technologies and media literacy programs that could allow them to compete for the opportunities afforded by new technology. These individuals are then trained in a team-based, community oriented, entrepreneurial system for delivering affordable high-quality IT services to small to medium-sized companies, non-profits, and government agencies. Prior art institutions generally employ a fragmented approach toward meeting society's needs vis-à-vis new technology. Those fragmented approaches include hierarchical, command/control structures that are calcified and reinforce the status quo. This has the effect of reinforcing a set of cultural practices that were defined decades ago in response to a very different set of circumstances and helps to perpetuate the widening gap between those with access to resources and those without. Furthermore, the prior art systems simply lack built-in mechanisms for adaptation.

In one embodiment, the method and system train and deliver individuals who understand the dynamics of whole environments where the individual participates in the ITTSO or client company in an adaptable role, allowing them to adapt as their interests and the environment change, as opposed to a more specialized or fragmented role. Here, the individuals are trained to acquire diverse perspectives in myriad different environments and to learn interdisciplinary collaboration.

Whereas in a typical prior art education cycle, students learn and then go to work, in some embodiments, students (i.e., individuals) join a work environment in the community where skilled professionals mix with and teach them in a regenerative learning process. This regenerative learning process is holistic and adaptive and responds to situational or environmental demands. Here, the regenerative learning process (and constituted system) coordinates and operates with and within the systems around it as a connected whole. Patterns at nested scales are identified to help create clarity around what's emerging within and about the system and the integrated whole. In one embodiment, this is done by intentionally identifying and designing interventions aimed at nodes within the integrated system to unblock pathways that benefit the whole integrated higher ordered system, not just isolated parts. By unblocking nodes and pathways new capacity and/or innovation occurs at these nodes.

In some embodiments, the nested scales—i.e., individuals, teams, organizations, communities, and ecosystems—change, evolve, or develop according to stages of development to improve capacity, relevance, and effectiveness. In one embodiment, the stages of development include a sensing stage, an engagement stage, a learning stage, and a working stage. Here, the stages progress forward in time according to cause and effect, as well as concomitantly through an iterative regeneration process. That is, for example, sensing proceeds throughout the entire development process.

In one embodiment, the stage of sensing includes the process of investigating, discovering, and intentionally optimizing initial conditions, such as identifying nodes in the whole system to target, such as, e.g., the pool from which pre-trained individuals are selected, the culture of a client business, the client industry, and the regional community and how these elements interact. Sensing allows for deliberate design aimed at critical nodes to foster future development and health of the system. Here, deliberate means intentional, anticipatory and aspirational. By focusing time and attention on the sensing stage of development, the strategies, initiatives, programs and the like that are developed and put into action will take full advantage of the opportunities presented in the ecosystem.

In one embodiment, sensing includes assessing the infrastructure of a community and the availability of underserved individuals in that community. Some of the challenges pertaining to technology education in many communities include, lack of access to the internet, inability to own a computer or a laptop, and schools with a lack of awareness of the changes in technology. In addition, most of these students do not have financial support to attend a four-year college or university for a degree in Computer Sciences. Some may have to work while they are still in school to support themselves. Furthermore, access to the internet is still not accepted as a basic commodity and access to a computer device for some of these youths is available only at the public library.

Some communities have organizations that understand the importance of science, technology, engineering, and math (STEM) careers and have access to individuals/students, but lack qualified and available trainers to provide industry in-demand IT skills. Furthermore, most STEM training programs provide only software coding classes and therefore may inadvertently select against certain demographics. However, not every job in IT is in a coding/developer role.

In one embodiment, the stage of engagement includes attracting or involving an individual, community—including educational and workforce development agencies, and business organizations—including companies, government agencies, non-profits, and the like, to participate in the subject system. Here, engagement includes supporting the development of the individual, team, organization, community or ecosystem being engaged, and allowing all components of the system to optimally evolve through the performance of the subject work and in response to the opportunities being revealed during the sensing and subsequent stages.

In one embodiment, a local resources organization is identified during the sensing stage. A preferred organization is a non-profit corporation whose mission is to obtain public and private sector employment for the unemployed and the under-employed residents of the local area. In another embodiment, the preferred organization receives government grant funding for workforce development.

During the engagement stage, after identifying the useful organization, the organization is engaged (e.g., by the ITTSO) first by focusing on what the different phases of software development life cycle are and the requisite skills to fulfill those phases, and how the students served by the organization can benefit from learning these skills for various job roles without having a four-year degree.

The next engagement step includes enrolling students from traditionally underrepresented and underserved communities are into technology training programs by the organization. In a preferred embodiment, the students came from all walks of life, youth and young adults between the ages of 17 and 23, students who were at jobs that they took a break from in order to have a chance to enter IT, students who had just graduated from high-school, students who had gone through a Bachelors' degree program in non-technology areas and were looking to switch to IT, students who had been in the IT industry for years and lost their jobs, and/or and students who were currently in jobs but had not been given the opportunity to get trained within their company. In one embodiment, greater than 50 percent of the students in the engaging phase have not been exposed to basic IT programming skills in schools or other sources of secondary education. In one embodiment, the students are enrolled in an IT training course provided by the community organization and taught or mentored by a trainer or mentor provided by the ITTSO.

In one embodiment, the trainer or mentor is a seasoned or senior IT professional currently practicing IT services. In a preferred embodiment, the trainer has been certified by Oracle, Microsoft, and/or Hadoop, or holds at least a Masters' degree in Computer Sciences.

In one embodiment, the course is conducted during a weekday after regular business hours for a period of about 1 month, about 2 months, about 3 months, 1-3 months, 1-2 months, 2-3 months, or up to 3 months.

In one embodiment, the trainer delivers customized training material to the students during the course. Customized training materials include materials regarding different coding languages based on industry demand. In a preferred embodiment, technical training materials are conveyed by the trainer using more common day-to-day terminology as opposed to technical syntax. For example, and by way of illustration only, the trainer may ask the student to give him a command a student to “write on the board.” The student may then reply, “pick up the marker, then walk to the board, then write.” The trainer would then write with the cap closed. The student would then realize that a computer would not understand that you have to “open the cap” before writing. The student would then amend the code to enable “write on the board” by providing the instruction to “remove the cap.” Other common day-to-day non-technical demonstrations may include physical metaphorical demonstrations such as the trainer walking toward the student and then suddenly falling to the floor to show what happens to a process when an “exception” happens when compiling a piece of code.

In one embodiment, according to the regenerative nature of the system and process, the training material is evaluated on a regular basis and revised if needed to ensure that it meets or exceeds the system requirements. Here, one objective is to deliver material of a content and manner to provide higher success of graduation and student confidence. In one embodiment, the ITTSO or the trainer continuously evaluates the success of the students in grasping the material.

In one embodiment, the course material includes a requirement for students to work on a final project. While a student may work on the project individually, in a preferred embodiment, the student works on the project in a group with one or more other students. In one embodiment, during the last week of the course, the student(s) present their project to industry professionals who judge the product of their projects and provide detailed feedback on every aspect of their work. This gives the students an understanding of the expected quality of their work product and feedback on what was taught from another professional's point of view that does not include their trainer.

In one embodiment, the training course begins with a student self-assessment describing the status of their working, learning, and private life before embarking on the course, and ends with a student self-assessment describing the status of their working, learning, and private life after the course material is delivered by the trainer and received by the students.

In some embodiments, after the course is completed, the training organization that provided the venue and funding for the training, the trainer, and/or the ITTSO facilitates or conducts speed interviews for the students. Local companies and organizations that have IT needs are invited to attend, to connect with the student(s), and to interview the student(s). In one embodiment, after the interview, the students and employers are given an option to prioritize their preferences. Students list in order of priority which employer they would like to work for, and employers list which of the students they would like to take on for internship. Here, the training organization then goes through an internal process of matching, then the students and employers are informed about the outcome, and employers then offer internships to these students. In some embodiments, the student(s) who received funding to take the subject course are then provided an additional 8 weeks of a paid internship through the training organization such that there is no cost to the employer company.

In one embodiment, >50%, >60%, >70%, >80%, or about 80% of the matriculating students graduate from the course work stage by keeping their attendance through the course duration. In one embodiment, >40%, >50%, >60%, >70%, >80%, or about 70% of the graduated students obtain an internship with the ITTSO or various other companies.

In some embodiments, the student-cum-intern is hosted by the ITTSO. Here, the intern works on enhancing ITTSO internal applications along different phases of the software development life cycle. In some embodiments, the phases of the software development include requirements analysis, design of the product, development of the code, software testing the changes made, and deploying those changes into Github and Gitlabs.

In some embodiments, upon completion of the internship, the ITTSO may choose to employ an intern as a paid apprentice based in part on the demand of the projects coming into the ITTSO pipeline. Here, the apprentice works on internal design projects, client-directed projects, and external consulting projects. In some embodiments, each and every intern is paid above the minimum wage salary established for a given local area.

In some embodiments, interns eventually go on to complete 3rd party certifications such as Oracle Certified Java Developers, JavaScript Certified by NCSA, Python Programmer by PCAP Certified. In some embodiments, interns eventually become certified to train other students into the courses taught by the ITTSO. In some embodiments, interns begin as developers and then go on to learn more than one coding language within the first year. In some embodiments, interns are trained in/as developer for various object-oriented programming languages, web designer, software tester, project coordinator or project manager roles, cyber security, data analyst, business analyst for cloud, and the like.

In one embodiment, the stage of learning, as for sensing and engagement, proceeds concomitantly with the other stages as part of a whole iterative regenerative process. Here, as the inner and outer environments of the system change, interventions are introduced into the system that substantially improve upon the contemporaneous or established conditions. In some embodiments, the interventions include (a) providing integrity by identifying the highest potential opportunity at individual, structural and systemic levels; (b) providing inclusion by assimilation and accommodation; and (c) defining the soft boundaries around a new environment from many vantage points to enable a holistic and multi-faceted description of the whole environment and system.

In one embodiment, the stage of learning applies to an apprentice hired by the ITTSO. Here, the ITTSO is hired by an established business (client company) in an industry needing of a software product (web or mobile application) to help automate their current process, or to develop a software product. The development of a software product for the client company is performed in several phases. The initial phase is to create a most viable product (MVP). This phase is performed by a senior information technology worker employed by the ITTSO acquired from offshore resources. The next phase is to enhance the product created in the initial phase. Here, the hired apprentice(s) and other junior resources work as a team, under the tutelage of a senior lead, mentor, and/or scrum leader, on enhancing the features for these products. This helps the apprentice and other junior resources implement their acquired design, code and testing skills on client facing projects with close mentoring from a senior lead. Daily standups are done within the teams and any roadblocks and/or delays are communicated to the team and scrum master on a daily basis. This process facilitates monitoring and strengthen of the skills of the resources, especially the training of the apprentices and other junior resources within the team.

In some embodiments, the senior resources in the ITTSO are tasked to lead hard skills training with the junior resources, and some of the junior resources are tasked to lead the team with other areas of improvement such as measuring success via gathering statistics of the work performed and monitoring the intern's progress. Here, the junior resources, which include apprentices, develop a sense of responsibility for the team's activities and enables them to interact with others on a regular basis to build interpersonal skills and comradery.

In one embodiment, MVP is built with an approach similar to “design thinking” as the underlying concept of this phase in order to create products that give emphasis on the user/client and create a design that is conducive to the user. Here, to develop and enhance the MVP, the team and its members dig deep into the client industry norms to understand the client business processes in that industry. Accordingly, respecting the knowledge and experience of the client business' industry and norms is critical for IT designers and developers to develop relevant useful products. Client industry knowledge helps to eliminate or dispel assumptions that may be made by the IT worker that may be incorrect or extremely unconventional to what that particular industry has been adopted.

For example and for illustration purposes only, an ITTSO client business was looking for ways to streamline and bring more automation into their day to day work processes which they had been following for over 30 years and also to reduce the stress on staff due to large changes in demand. The client was currently using a software product that was considered a top-rated IT product in the field, but the client business employees were required to learn UNIX commands to be able to use this software, which was not yet even on the cloud platform. The client worked for 2 years to learn to master the software and failed despite many training sessions. The currently-used software was designed as a one-size-fits-all for companies that operated within a broad industry sector to which the client business was a small and specialized subset with different process requirements.

Here, an ITTSO team (comprising junior resources including one or more apprentices as described above) applied a 6-month immersive process to determine and develop an understanding of the internal workflow of the client business over the prior 30 years of operation. After 6 months of immersive design sessions, the team started to build a software web application that was based on the determined and developed understanding of the client workflow and designed to flow with the workflow—with user interface and user experience taken into strong consideration.

In one embodiment, the stage of working within the subject regenerative process includes sharing learning about what happened, what worked, what failed, what remains essential to the process and system, and what can be discarded. Here, some activities or initiatives are terminated, and other activities or initiatives are established or expanded. Importantly, the working step views the entire system as an integrated whole instead of an amalgam of parts, and adjusts the parts accordingly to benefit the whole.

It is generally understood that well-trained and mentored individuals from non-traditional backgrounds may still face hurdles in the hiring process due to not having a formal bachelor's degree in computer sciences degree and/or two or more years of relevant industry experience. Thus, in some embodiments, the ITTSO apprentice(s) having completed the learning phase is inducted into the working phase of the regenerative process/system.

In one embodiment, the working phase comprises constituting and deploying a pod system (pod). Here, the pod team members execute work obtained from a client company that is scored out for them to work on, usually for the period of about one quarter. The work usually consists of enhancing already existing client applications—e.g., i.e., web and mobile—with new features.

In some embodiments, pods include 4-6 team members. A pod consists of at least one experienced senior lead developer who is willing to lead a group of developers with varied skill talent level and one developer who can work independently, and two or three junior developers including an apprentice(s). A pod delivers skills that are high in-demand, such as, e.g., Java. JavaScript, React, Node, Ruby on Rails, C#, Android and iOS Mobile app development. In some embodiments, the pod also provides roles such as quality assurance and project coordination/management.

Here, the average cost of operation of a pod is below market-value and provides low risk to the client business by demanding payment from the client business only upon the completion of each monthly milestone established per agreement. In preferred embodiments, the pod operates at ITTSO premises with occasional work at client site, thereby enabling the ITTSO to continue to closely monitor pod progress and engage the pod in continued training as needed.

In one embodiment, the pod observes the client business and gains knowledge of the future pipeline of projects in client business. Here, the ITTSO or pod team can prepare for any future pipeline project requirements well ahead and prepare the resources per clients upcoming demands.

In one embodiment of the working phase of the regenerative process and system, after period of time of operating a pod, the ITTSO and the client business evaluate the apprentice and the apprentice's and give the apprentice an opportunity to pick between continuing with employment with the ITTSO or moving to the client business under a standard fee agreement per the market standards. In one embodiment, the period of time is about 6 months, about 12 months, about 18 months, about 24 months, about 30 months, about 36 months, at least 6 months, at least 12 months, at least 18 months, at least 24 months, at least 30 months, at least 36 months, or no more than 36 months.

In some embodiments of the working phase of the regenerative process and system, in addition to providing employment opportunities and technology training to the apprentice, the apprentice(s) is also trained in other areas of professional development, such as financial education, and participation in closed discussions with industry experts who share their insights of the industry and trends of the technology. Here, pods have well balanced knowledge sharing opportunities not only within the pod but across pods to keep adding more skills to the skill portfolio of the apprentice.

### EMBODIMENTS

Turning to FIG. 1, in one embodiment, the invention is a system 100 for training students in information technology and providing high quality low cost information technology services to a client business. Here, the system 100 includes multiple subsystems or cells 160 that are interconnected and distributed across a large geographic area, such as a region of a country, a country, a region of a continent, a continent, several continents, or the entire world. In some embodiments each cell 160 includes components embedded in a local area or community 110. In some embodiments, the local area is a metropolitan area, combined statistical metropolitan area, a multistate economic zone, or the like.

In one embodiment, the components include a pool of students 120, an information technology training and service organization (ITTSO) 130, a training organization 140, and a client business 150.

In one embodiment, the pool of students 120 includes unconventional students. Here the unconventional students may be selected from (a) underrepresented groups, such as women and minorities, (b) socioeconomically oppressed groups, (c) students with no or little IT exposure seeking to start or change a career, and/or (d) students with little or no post-secondary education.

In one embodiment, the ITTSO is an organization that provides IT products, service, and training. The ITTSO can be a for-profit company, a non-profit company, a division within a larger organization, a quasi-government organization, or a NGO. In a preferred embodiment, the ITTSO is a for-profit company that provides IT products, service, and training.

In one embodiment, the training organization 140 is a workforce development agency, a community college, a private vocational college, or the like. In a preferred embodiment, the training organization 140 obtains funding or helps students 120 obtain funding to provide classroom training. Here, funding can be from private or public sources in the form of forgivable loans or grants.

In one embodiment, the client business 150 is any organization that needs information technology advice, service, or product. Organizations include small businesses, medium-sized businesses, and large businesses, or subunits or divisions within businesses. Organizations also include non-profit companies, universities, colleges, and the like. Organizations also include government agencies.

In one embodiment of the system 100, the training organization 140, with or without assistance from the ITTSO 130, recruits students 120 from the local area community 110 to participate in an IT training program. The ITTSO 130 provides one or more experienced IT professionals as trainers to teach the students 120 at the training organization 140 venue.

Students 120 graduating from the training program are inducted as interns within the ITTSO 120 or the client business 130 for further training and development. In one embodiment, one or more interns become apprentices in the ITTSO 130. In one embodiment, one or more apprentices become information technology workers in the ITTSO 130 or a client company 150.

Turning to FIG. 2, the invention provides a financial benefit system for the delivery of high quality information technology services, advice, and/or products to client businesses 250. Here, the ITTSO 230 trains or facilitates the training 225 of students 220 to provide information technology services 235 to the client business 250. Here, the student 220 is selected from a group of unconventional students. The unconventional students may be selected from (a) underrepresented groups, such as women and minorities, (b) socioeconomically oppressed groups, (c) students with no or little IT exposure seeking to start or change a career, and/or (d) students with little or no post-secondary education.

By employing a project-based and industry immersion method, the trained students 220 are employed by the ITTSO 230 or the client business 250 to provide 265 an economic benefit 270 to the client business 250. Here, the economic benefit 270 includes decreased costs 272 and increase quality 274 to the client 250.

Turning to FIG. 3, in one embodiment, the system includes a student development system 300. The student development system 300 includes a novice 310, who becomes a trainee 320, who becomes an intern 330, who proceeds to becomes an apprentice, who becomes a worker 350. It should also be noted that these levels of student development are also applied to the development of different information technology skills, such as coding in one language or another, analyzing workflows, counseling clients, and the like. For example and to illustrate this concept, a worker in coding may be a novice when it comes to client workflow analysis, or a worker in client workflow analysis may be a novice when it comes to coding.

Here, the novice individual 310 is selected from a group of individuals seeking to learn to become an information technology worker 350. A novice individual 310 can be an individual previously unexposed to some level information technology engineering (i.e., naïve individual or pre-trainee). Here, the novice individual 310 is selected from a group of unconventional students. The unconventional students may be selected from (a) underrepresented groups, such as women and minorities, (b) socioeconomically oppressed groups, (c) students with no or little IT exposure seeking to start or change a career, and/or (d) students with little or no post-secondary education.

Next, the novice 310 is enrolled in a paid-for information technology training program and becomes a trainee 320. The trainee 320 is trained in the classroom with information technology course material and project-based learning, executes a project, and presents the project to a group of judges selected from industry. The trainee 320 and the ITTSO or client business mutually select a trainee 320 to become an intern 330 in the ITTSO or client business.

The intern 330 works on less complex information technology projects within the ITTSO or client business. The intern 330 is paid via grants or forgivable loans and therefore does not cost the ITTSO or client business. Once the intern 330 has successfully completed the internship and has learned the basics of software development or other information technology-related skills, the ITTSO or client company selects an apprentice 340 from the poll of successful interns 330.

The apprentice 340 is employed by the ITTSO or a client company at a wage that is above the minimum wage set for the local area community. In a preferred embodiment, the apprentice 340 is employed by the ITTSO to work within a team (pod) that includes a mentor and other more experienced information technology workers to provide information technology consulting advise, service, and products to client businesses. Here, the apprentice 340 is trained in information technology engineering (hard skills) and soft skills, such as resume building and active listening. After 1, 2, or 3 years as an apprentice, the apprentice 340 is hired as a worker 350 by the ITTSO or a client company to provide information technology services.

Turning to FIG. 4, in one embodiment, the invention provides a method 400 of training students to become information technology workers, providing high quality low cost information technology services to industry, and advancing economic development in a local area community.

In one embodiment, the method includes the steps (phases of the cycle) of sensing 410, engaging 420, learning 430, and working 440. This sequence of steps is applied to myriad stages across the information technology pedagogical and service provision process and system (see FIGS. 7 and 8). It should also be noted that these phases are also applied to the development of different information technology skills, such as coding in one language or another, analyzing workflows, counseling clients, and the like.

Sensing 410 includes the processes of investigating, discovering, and intentionally optimizing initial conditions, such as identifying nodes in the whole system to target, such as, e.g., the pool from which pre-trained individuals are selected, the culture of a client business, the client industry, and the regional community and how these elements interact. Here, the whole-system-to-target includes the local area community needing economic development and workforce development, which included undertrained students, underrepresented students, and/or underemployed workers. The whole-system-to-target also includes client business industries that need relevant and high quality information technology services, products, and advice that account for and integrate with the business' specific workflows and processes.

Engaging 420 includes bringing students, interns, apprentices, and/or workers together with the ITTSO or a client company to articulate nodes within the subject whole-system-to-target and develop, articulate, and executes potential engineering or soft-skill solutions to affect those nodes to strengthen the whole-system. For example, turning to FIG. 5, engaging 500 as it relates to the initial training of the trainee (see also subprocess 820), includes a sequential series of steps that start with a trainee and ends with an intern. Here, a novice or naïve student provides an initial intake self-assessment 510 related to their personal and professional life and the novice is becomes a trainee. Next, the trainee is delivered course material 520 prepared by and then delivered by an ITTSO worker at a training organization facility or on-line. During the formal course, the trainee participates in a project-based learning project 530 within a team of trainees, and then delivers the product of the project 540 to judges selected from industry, who evaluate the project 550. In one embodiment, the course material 520 and delivery of that material is evaluated, refined, and optimized 525 throughout, before, and after each engagement cycle 500.

In one embodiment, the trainee provides an exit self-assessment 560.

Next, the trainee participates in a speed interview process 570 with one or more client business representatives and/or ITTSO representatives. Following the speed interviews 570, the client business (including the ITTSO in some embodiments) and the trainee each select their favorite partner for employment, which culminates with a match between a trainee and a client business (or ITTSO) 580. Once matched, the trainee becomes an intern and enters an internship 590 with the matched client business.

In some embodiments, the internship provides the intern opportunities to learn, in a hands-on manner, the hard and soft skills required to be a successful information technology professional. In one embodiment, the intern is paid through a grant or forgivable load administered by the training organization. n

Turning back to FIG. 4, learning 430 includes the steps of tracking the changes in the conditions of the inner and outer environments of the system and introducing into the system interventions that improve upon the contemporaneous or established conditions. In some embodiments, the interventions include (a) providing integrity by identifying the highest potential opportunity at individual, structural and systemic levels; (b) providing inclusion by assimilation and accommodation; and (c) defining the soft boundaries around a new environment from many vantage points to enable a holistic and multi-faceted description of the whole environment and system.

By way of example, learning 430, as it applies to training a student in any particular new information technology skill, regardless of the student's mastery of any prior (non-new as it relates to the student) information technology skill, is shown in more detail in FIG. 6. Here, the learning phase 600 includes a sequential process of a student starting to learn a new skill 610, then the student, as an individual contributor or as a team member, helps create or enhance a most viable product 620, participates in team standups and receives mentorship from a senior worker 630, provides input or services on the team in some aspect of the project as a leader in that aspect to develop leadership and responsibility skills 640, the team or the student or a more senior worker engages and investigates/interrogates a client company to understand to some degree of intimacy and detail one or more workflows or the client company 650, resulting in the student attaining an enhanced skill level 660.

In some embodiments, the learning process 600 includes constituting a team comprising interns and/or apprentices and other more seasoned workers, wherein the team provides mentoring to the student 630 and teaches not only hard information technology skills (e.g., coding and software development), but soft skills such as project management, time management, client management, leadership, and responsibility.

Turning back to FIG. 4, working 440 includes, in some embodiments, constituting and deploying teams to execute information technology work obtained from a client company. In some embodiments, the work is conducted in teams having at least one experienced senior lead developer who is willing to lead a group of developers with varied skill talent level and one developer who can work independently, and two or three junior developers including an apprentice(s). Here, the team delivers work product with a below market-value cost with low risk to the client business by demanding payment from the client business only upon the completion of each monthly milestone established per agreement. In preferred embodiments, the team is employed by the ITTSO, which contracts with the client business.

Turning to FIG. 7, in one embodiment, the system and/or process 700 of the invention provides the step or element of PROBES 710, followed by TRAINS 720, followed by SOLVES 730, followed by PODS 740.

In one embodiment, the probes process 710 includes reaching into the local area community to induct interested novices, especially those with no financial backing to go to a four-year college or those who are out of work, into the training program 720. Preferably, the matriculating trainees are eligible for federal or other grants and are eligible to receive 100% tuition reimbursement.

In one embodiment, the trains process 720 includes (a) matriculating or inducting novices into a grant-funded information technology course operated by a training organization (e.g., as described herein above), (b) providing to the trainees a short (e.g., about 1 to about 3 months long, preferably about 3 months long) but intense course on a specific in-demand-skills in IT (e.g., Java, JavaScript, Angular, C#, and project management skills). These trainings are conducted by IT professionals who have worked in the industry as developers and/or earned the relevant certificates to conduct the trainings. Graduated trainees are interns, who receive additional hands-on training within the ITTSO or client businesses.

In one embodiment, the solves process 730 includes exposing trainees to local technology employers for potential employment as interns. This exposure is mediated by an ITTSO leader who interviews the trainees from the class. If a trainee is approved for an internship with the ITTSO, the trainees-cum-interns are offered positions to further enhance the skills they learned by working on real world projects that are developed internally by the ITTSO.

In one embodiment, for about two months, the interns apply the new skills and are paid to work as interns through a private sector of government grant or forgivable loan. During this stage the interns are exposed to many personal and professional skills and taught various development and delivery methodologies, and also how to give constructive feedback and teamwork.

In one embodiment, in the middle of the solves stage, the ITTSO is given a choice to hire the interns full time into the organization. The decision of whether to hire to intern (who would then become an apprentice) is based on the internal workload of the ITTSO and its belief in its ability to further develop the individual, and on the qualifications and attributes of the chosen intern. Those interns that are selected and accept the offer to join the ITTSO are hired into the ITTSO as paid apprentices, where they work on small scale, in-house projects, so that the ITTSO lead team can personally oversee the professional growth of the apprentice.

In the final stage of the program 700, each apprentice (and in some cases an intern) is placed into an ITTSO “Pod” 740. In one particular embodiment, the pod includes two experienced senior associates working with about three junior associates. Here, the pod is then given a scope of work from an IT project on behalf of a client business to complete, which includes monthly milestones. Here, the ITTSO is paid only when the scope of work that is agreed upon by the client business and the ITTSO is met to the client's standards.

In one embodiment, the learning for apprentices/employees (i.e., junior associates) is constant over the next 1-3 years as the junior associates are learning while getting paid. Here, each junior associate is given tasks that are appropriate for their skill level.

Turning to FIG. 8, the invention provides a regenerative process and system for training IT workers and providing high quality, low cost IT services to client companies by incorporating the steps of sensing 410, engaging 420, learning 430, and working 440 (as disclosed in FIG. 4) at each of the stage of probes 710, trains 720, solves 730, and pods 740 (as disclosed in FIG. 7) to induct a novice into the training program and produce a trainee 810, to train the trainee and produce an intern 820, to train the intern and produce an apprentice 830

By regenerative, what is meant is that the execution and completion of each stage involves the same category of sequential steps (phases), which, by continuously sensing, engaging, learning, and working, feeds forward and backward to enhance and improve the quality and efficiency of each succeeding stage and each preceding stage of a new cycle. Each time a stage cycle 800 is completed, the process becomes more efficient, of higher quality, and of lower relative cost due to regeneration between phases, stages, and cycles.

The invention shall not be limited to the summary and detailed description of certain embodiments of the invention, but by the claims appended hereafter.

1. An information technology system comprising:
a. a regenerative training cycle;
b. a community;
c. a plurality of students located within said community;
d. an information technology training and service organization (ITTSO) that provides a trainer that trains one or more students;
e. a training organization located within said community;
f. a client that uses information technology services, advice, or products; and
g. an information technology product.

2. The information technology system of claim 1, wherein said community comprises a geographic region.

3. The information technology system of claim 2, wherein the geographic region comprises one or more of (i) part of one or more states, (ii) a combined statistical area, (iii) a metropolitan statistical area, (iv) a micropolitan statistical area, (v) a county, and (vi) a city or town with a population less than 500,000.

4. The information technology system of claim 1, wherein the community is an economic trading unit that encompasses at least 10 million USD in trade volume.

5. The information technology system of claim 1, wherein the regenerative training cycle comprises four stages comprising a probe stage, a trains stage, a solves stage, and a pods stage.

6. The information technology system of claim 5, wherein each of said four stages comprises four phases comprising a sense phase, an engage phase, a learn phase, and a work phase.

7. The information technology system of claim 1, wherein the ITTSO is a for-profit company that provides information technology training and services.

8. The information technology system of claim 1, wherein the training organization provides the venue to a part of the regenerative training cycle.

9. The information technology system of claim 1, wherein the training organization is a workforce development agency or a community college.

10. The information technology system of claim 1, wherein the plurality of students comprises a novice, a trainee, an intern, an apprentice, and a worker.

11. The information technology system of claim 10, wherein the apprentice is employed by the ITTSO.

12. The information technology system of claim 10, wherein the intern is employed by the ITTSO or the client.

13. The information technology system of claim 1, wherein the client is a small or medium sized company.

14. The information technology system of claim 1, wherein the information technology product comprises one or more of an information technology worker, a software product, software development services, and software advice.

15. A method of training an information technology worker, the method comprising:
a. inducting a novice into a training program, wherein the novice becomes a trainee;
b. delivering course material to the trainee for a first period of time;
c. receiving a project presentation from the trainee after the first period of time;
d. inducting the trainee into an internship, wherein the trainee becomes an intern;
e. training the intern in a work environment for a second period of time;
f. inducting the intern into a paid position in an organization, wherein the intern becomes and apprentice; and
g. mentoring the apprentice for a third period of time.

16. The method of claim 15 comprising inducting the apprentice into a full time paid position after the third period of time, wherein the apprentice becomes a worker.

17. The method of claim 15, wherein the course material is delivered by a trainer employed by an information technology training and service organization (ITTSO) and the project is received and evaluated by industry professionals.

18. The method of claim 15, wherein the first period of time is about 3 months.

19. The method of claim 15, wherein the second period of time is about 3 months-12 months and the third period of time is about 1 year-4 years.

20. A method of providing an information technology product, the method comprising:
a. training an intern, apprentice, or worker in information technology skills according to claim 15;
b. engaging a client business;
c. interrogating the client business, thereby understanding a workflow of the client business; and
d. providing an information technology product to the client business at below market cost for the level of quality of the information technology product,
wherein said information technology product comprises (i) an information technology worker, (ii) a software product, (iii) software development services, or (iv) software advice.
